(19) United States
(12) Patent Application Publication
(10) Pub. No.: US 2018/0192424 A1
(43) Pub. Date: Jul. 5, 2018

(54) Information Transmission Apparatus and Method and Communications System

(71) Applicant: FUJITSU LIMITED, Kawasaki-shi (JP)

(72) Inventors: Jian ZHANG, Beijing (CN); Xin WANG, Beijing (CN)

(73) Assignee: FUJITSU LIMITED, Kawasaki-shi (JP)

(21) Appl. No.: 15/906,393

(22) Filed: Feb. 27, 2018

Related U.S. Application Data
(63) Continuation of application No. PCT/CN2015/089448, filed on Sep. 11, 2015.

(51) Int. Cl. H04W 72/04; H04L 27/34

(52) U.S. Cl. CPC H04W 72/0473; H04L 27/3411; H04L 27/3444

(57) ABSTRACT

An information transmission apparatus and method and a communications system. The information transmission method includes: performing constellation transform respectively on first symbols to be transmitted to a first receiving device and second symbols to be transmitted to a second receiving device; performing power allocation respectively on the constellation transformed first symbols and the constellation transformed second symbols and superimposition, to form superimposed symbols; and interleaving imaginary parts and real parts of the superimposed symbols and then transmitting them. Hence, data demodulation performance of the UE may further be improved based on conventional NOMA.

### CROSS REFERENCE TO RELATED APPLICATIONS

This application is a continuation application of International Application PCT/CN2015/089448 filed on Sep. 11, 2015, the entire contents of which are incorporated herein by reference.

### TECHNICAL FIELD

This disclosure relates to the field of communications technologies, and in particular to an information transmission apparatus and method and a communications system based on a nonorthogonal multiple access (NOMA) system.

### BACKGROUND

One of demands of a 5th generation (5G) mobile communications system is to support a system capacity higher than that of a 4G system (such as 1000 times) and the number of connected terminals larger than that of the 4G system (such as 100 times). Every generations of mobile communications employ an orthogonal multiple access technique. It is shown by studies that the nonorthogonal multiple access technique may achieve a capacity field larger than that of the orthogonal multiple access technique, and such a theoretical indication makes the nonorthogonal multiple access technique became one of key techniques of the studies of 5G

One of means for achieving nonorthogonality is nonorthogonality in a power domain, and its representative technique, NOMA, has been included in the discussion scope of LTE-A Release 13. The NOMA technique is based on a superimposed code theory, in which a transmitting device transmits complex constellation symbols formed by superimposition, user equipment (UE) of relatively poor channel conditions is able to demodulate data of itself, and UE of relatively good channel conditions is able to further refine the constellation. For a case where a transmitting device uses a single antenna, the NOMA technique is able to theoretically achieve all capacity fields of downlink broadcast channels and uplink multi-access channels. For NOMA downlink transmission, its transmitted signals are in the following form of a superimposed symbol:

x=\sqrt{Eₛ}(\sqrt{P₁}a+\sqrt{P₂}b);

where, a denotes a symbol to be transmitted to the UE of relatively poor channel conditions (which shall be referred to as far UE or a first receiving device), b denotes a symbol to be transmitted to the UE of relatively good channel conditions (which shall be referred to as near UE or a second receiving device), Eₛ denotes a total energy or total power of the superimposed symbol, and P₁ and P₂ denote power allocation coefficients, satisfying a condition of P₁+P₂=1.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

Embodiments of this disclosure provide an information transmission apparatus and method and a communications system, so as to further improve data demodulation performance of UE.

According to a first aspect of the embodiments of this disclosure, there is provided an information transmission apparatus, configured in a nonorthogonal multiple access system, the information transmission apparatus including:

a constellation transforming unit configured to perform constellation transform respectively on first symbols to be transmitted to a first receiving device and second symbols to be transmitted to a second receiving device;

a symbol superimposing unit configured to perform power allocation respectively and superimposition on the constellation transformed first symbols and the constellation transformed second symbols, to form superimposed symbols;

an imaginary and real interleaving unit configured to interleave imaginary parts and real parts of the superimposed symbols; and

an information transmitting unit configured to transmit the superimposed symbols with the imaginary parts and real parts being interleaved.

According to a second aspect of the embodiments of this disclosure, there is provided an information transmission method, applicable to a nonorthogonal multiple access system, the information transmission method including:

performing, by a transmitting device, constellation transform respectively on first symbols to be transmitted to a first receiving device and second symbols to be transmitted to a second receiving device;

performing power allocation respectively on the constellation transformed first symbols and the constellation transformed second symbols and superimposition, to form superimposed symbols;

interleaving imaginary parts and real parts of the superimposed symbols; and

transmitting the superimposed symbols with the imaginary parts and real parts being interleaved.

According to a third aspect of the embodiments of this disclosure, there is provided a communications system, configured to perform nonorthogonal multiple access, the communications system including:

a transmitting device configured to perform constellation transform respectively on first symbols to be transmitted to a first receiving device and second symbols to be transmitted to a second receiving device, perform power allocation respectively on the constellation transformed first symbols and the constellation transformed second symbols and superimposition, to form superimposed symbols, and interleave imaginary parts and real parts of the superimposed symbols and then transmit the superimposed symbols;

the first receiving device configured to receive signals transmitted by the transmitting device and de-interleave imaginary parts and real parts of the signals, in a case where a modulation scheme of the second receiving device is unknown, take the second symbols as interference, and demodulate and decode the first symbols based on a constellation used by the first symbols, and in a case where the modulation scheme of the second receiving device is known, demodulate and decode the first symbols based on a complex constellation formed by superimposing the first symbols and the second symbols; and

the second receiving device configured to receive signals transmitted by the transmitting device and de-interleave imaginary parts and real parts of the signals, and demodulate and decode the second symbols based on the complex constellation formed by superimposing the first symbols and the second symbols.

An advantage of the embodiments of this disclosure exists in that the transmitting device performs constellation transform respectively on the first symbols to be transmitted to the first receiving device and the second symbols to be transmitted to the second receiving device, performs power allocation and superimposition to form superimposed symbols, and then interleaves the imaginary parts and real parts of the superimposed symbols. Hence, data demodulation performance of the UE may further be improved on the basis of the conventional NOMA.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a flowchart of the information transmission method of Embodiment 1 of this disclosure;

FIG. 2 is a schematic diagram of mapping superimposed symbols onto time-frequency resource grids when no real part and imaginary part interleaving is performed;

FIG. 3 is a schematic diagram of shifting the imaginary parts of the superimposed symbols of Embodiment 1 of this disclosure;

FIG. 4 is a schematic diagram of the imaginary parts of the superimposed symbols after the shift of Embodiment 1 of this disclosure;

FIG. 5 is a schematic diagram of a constellation of the superimposed symbols after the constellation transform of Embodiment 1 of this disclosure;

FIG. 6 is another schematic diagram of the constellation of the superimposed symbols after the constellation transform of Embodiment 1 of this disclosure;

FIG. 7 is a further schematic diagram of the constellation of the superimposed symbols after the constellation transform of Embodiment 1 of this disclosure;

FIG. 8 is an overall schematic diagram of performing information transmission of Embodiment 1 of this disclosure;

FIG. 9 is a schematic diagram of performance comparison of Embodiment 1 of this disclosure;

FIG. 10 is another schematic diagram of performance comparison of Embodiment 1 of this disclosure;

FIG. 11 is a further schematic diagram of performance comparison of Embodiment 1 of this disclosure;

FIG. 12 is still another schematic diagram of performance comparison of Embodiment 1 of this disclosure;

FIG. 13 is yet another schematic diagram of performance comparison of Embodiment 1 of this disclosure;

FIG. 14 is yet still another schematic diagram of performance comparison of Embodiment 1 of this disclosure;

FIG. 15 is a still further schematic diagram of performance comparison of Embodiment 1 of this disclosure;

FIG. 16 is a yet further schematic diagram of performance comparison of Embodiment 1 of this disclosure;

FIG. 17 is a yet still further schematic diagram of performance comparison of Embodiment 1 of this disclosure;

FIG. 18 is even another schematic diagram of performance comparison of Embodiment 1 of this disclosure;

FIG. 19 is an even further schematic diagram of performance comparison of Embodiment 1 of this disclosure;

FIG. 20 is a schematic diagram of the information transmission apparatus of Embodiment 2 of this disclosure;

FIG. 21 is another schematic diagram of the information transmission apparatus of Embodiment 2 of this disclosure;

FIG. 22 is a schematic diagram of a structure of a transmitting device of Embodiment 2 of this disclosure; and

FIG. 23 is a schematic diagram of the communications system of Embodiment 3 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

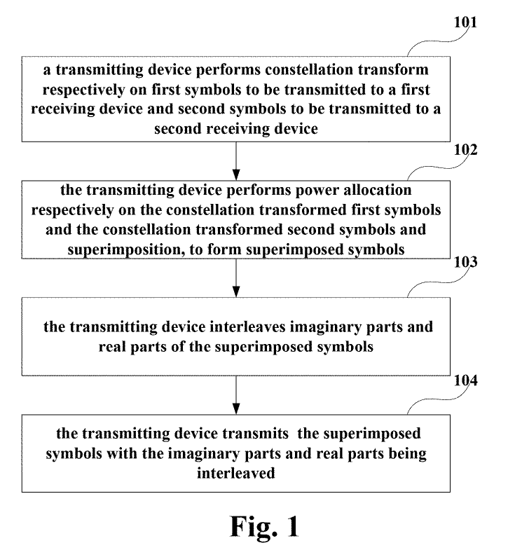

The embodiment of this disclosure provides an information transmission method, applicable to an NOMA system. FIG. 1 is a flowchart of the information transmission method of the embodiment of this disclosure. As shown in FIG. 1, the information transmission method includes:

Block 101: a transmitting device performs constellation transform respectively on first symbols to be transmitted to a first receiving device and second symbols to be transmitted to a second receiving device;

Block 102: the transmitting device performs power allocation respectively on the constellation transformed first symbols and the constellation transformed second symbols and superimposition, to form superimposed symbols;

Block 103: the transmitting device interleaves imaginary parts and real parts of the superimposed symbols; and

Block 104: the transmitting device transmits the superimposed symbols with the imaginary parts and real parts being interleaved.

In this embodiment, the transmitting device may be a base station in the NOMA system, the first receiving device may be UE of relatively poor channel conditions (which shall be referred to as far UE), and the second receiving device may be UE of relatively good channel conditions (which shall be referred to as near UE). However, this disclosure is not limited thereto; for example, it may be applicable to other application scenarios.

It should be noted that FIG. 1 only schematically shows some blocks or steps related to this disclosure, and techniques related to NOMA and orthogonal frequency division multiplexing (OFDM) may be referred to for other blocks or steps for transmitting information (such as channel coding, constellation modulation, resource mapping, and OFDM symbol modulation, etc.), which shall not be described herein any further.

In block 101 of this embodiment, phase rotation may be performed on the first symbols to be transmitted to the first receiving device by a rotation angle of θ₁, and phase rotation may be performed on the second symbols to be transmitted to the second receiving device by a rotation angle of θ₂.

For example, rotation angles of θ₁ and θ₂ are respectively designated for the far UE and the near UE, and for a case where symbols aᵢ and bᵢ are respectively transmitted to the far UE and the near UE, the following superimposition form may be obtained:

xᵢ=\sqrt{Eₛ}(\sqrt{P₁}aᵢ·e^{j}^{^{θ}}¹+\sqrt{P₂}bᵢ·e^{j}^{^{θ}}²);

where, i=1, . . . , N, and N denotes N symbols are consecutively transmitted.

Here, it is assumed that the rotation is clockwise in a complex plane, i.e., being multiplied by e^{-j}^{^{θ}}, or it may also be counterclockwise, i.e., being multiplied by e^{jθ̅}, and at this moment, θ̅=−θ. Description shall be given by uniformly using an e^{-j}^{^{θ}} rotation model, and based upon which, an angle when e^{j}^{^{θ̅}} rotation is used is easy to be obtained.

It should be noted that the manners of the constellation transform in block 101 are not limited thereto; for example, a transform manner of complex constellation described below where symmetrical distribution is obtained may also be used.

In block 103 of this embodiment, the real parts and imaginary parts of the superimposed symbols are interleaved.

For example, real parts and imaginary parts of all symbols x₁, x₂, K, x_{N} to be transmitted are interleaved. And an interleaving rule should follow as possible that a real part and an imaginary part belonging to the same xᵢ are made to experience independent channel fade.

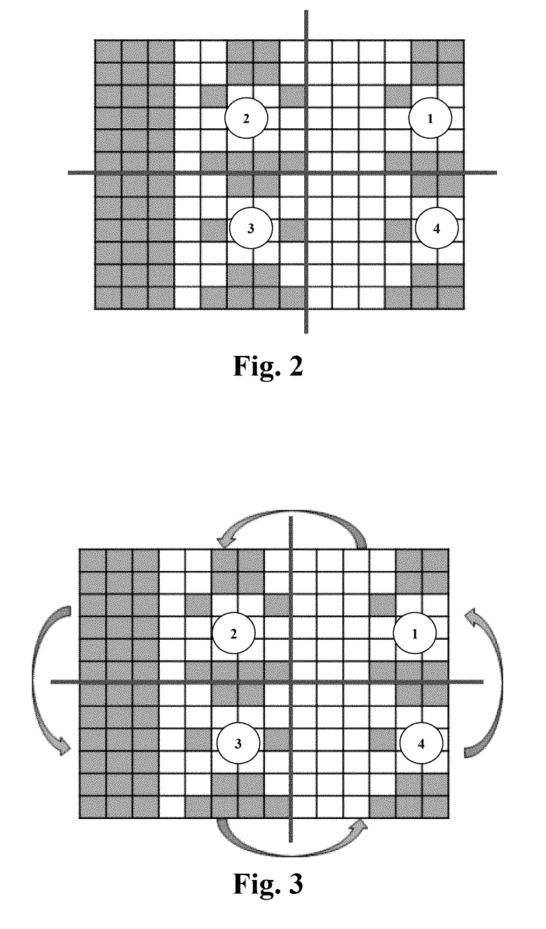

FIGS. 2-4 show a schematic case of an interleaving method taking a physical resource block as an example. For example, FIG. 2 is a schematic diagram of mapping superimposed symbols onto time-frequency resource grids when no real part and imaginary part interleaving is performed. As shown in FIG. 2, the gray color denotes reference signals and positions of control channels, and the white color denotes positions of data onto which the superimposed symbols may be mapped.

FIG. 3 is a schematic diagram of shifting the imaginary parts of the superimposed symbols of the embodiment of this disclosure. In particular implementation, real parts of data symbols are not interleaved, that is, positions of the real parts are not changed. And imaginary parts of the data symbols are interleaved, and an interleaving manner is as shown in FIG. 3.

For example, the imaginary parts of the data symbols, together with reference signals, are cyclically shifted in a time-axis direction by

$$⌈ \frac{T}{2} ⌉$$

OFDM symbols; where, T denotes the number of OFDM symbols in a subframe with physical downlink control channels (PDCCHs) being removed; and are cyclically shifted in a frequency-axis direction by

$$⌈ \frac{F}{2} ⌉$$

subcarriers; where, F denotes a total number of subcarriers occupied by a data area.

FIG. 4 is a schematic diagram of the imaginary parts of the superimposed symbols after the shift of the embodiment of this disclosure, in which a case of position arrangement after the cyclical shift is shown.

In this embodiment, for the grid matrix in FIG. 4, the imaginary parts of the data symbols may be read column by column in a sequential order of frequency and time (the reference signals are not read), and then all the read imaginary parts of the data symbols are written into the grid matrix (with the exception of the PDCCH area) shown in FIG. 2 column by column in a sequential order of frequency and time, thereby achieving interleaving of the imaginary parts of the symbols to be transmitted. At this moment, complex symbols in each resource element constituted by original real parts and interleaved imaginary parts are interleaved symbols, and on which OFDM symbol shaping and transmission may be performed. And an actually baseband signal model for transmitting may be expressed as:

χᵢ=Re{xᵢ}+j·Im{xₖ};

wherein, a relationship between i and k is dependent on an interleaving manner that is used. The interleaving process makes a real part and an imaginary part of xᵢ experienced independent channel fade, and as the real part and the imaginary part of xᵢ respectively contain all information on real parts and imaginary parts of aᵢ, bᵢ, equivalent to transmitting two copies of information on aᵢ, bᵢ in independent channels, a diversity effect will be obtained, which may further obtain diversity gains on the basis of conventional NOMA, and improve data demodulation performance.

It is assumed that superimposed symbols on which constellation rotation has been performed before interleaving are:

x=\sqrt{Eₛ}(\sqrt{P₁}a·e^{-j}^{^{θ}}¹+\sqrt{P₂}b·e^{-j}^{^{θ}}²);

wherein, subscripts are omitted. Let z=\sqrt{P₁}a·e^{-j}^{^{θ}}¹+\sqrt{P₂}b·e^{-j}^{^{θ}}² denote a complex constellation point symbol formed by superimposition, and because the real part and the imaginary part are interleaved, a real part and an imaginary part of the complex constellation z experience independent channel fade, the real part of z being denoted by z _{R}, and a channel experienced by z_{R} being denoted by h_{R}; likewise, the imaginary part of z is denoted by z_{I}, and a channel experienced by z_{I} is denoted by h_{I}. Received signals to which they correspond respectively are denoted by y_{R}, y_{I}, then,

y_{R}=h_{R}\sqrt{Eₛ}z_{R}+n_{R}

y_{I}=h_{I}\sqrt{Fₛ}z_{I}+n_{I};

where, n_{R}, n_{I} denote Gaussian white noises.

It should be noted that the above description is given by taking that the positions of the real parts are not changed and the imaginary parts are shifted. However, this disclosure is not limited thereto; for example, the positions of the real parts may be changed, only if a rule is followed as possible that a real part and an imaginary part pertaining to the same x, experience independent channel fade.

In this embodiment, before the transmitting device performs constellation transform on the second symbols to be transmitted to the second receiving device, the second symbols may be transformed, so that bits to which constellation points in a complex constellation formed by the superimposed symbols correspond satisfy Gray mapping.

For example, for the data transmission of the near UE, Gray mapping transform may be performed on the basis of constellation points of the far UE, so that a complex constellation formed by final superimposed symbols also satisfies the Gray mapping, that is, there exists only one bit of difference between neighboring constellation points in the complex constellation, thereby bringing in improvement of bit error rate performance.

Following description shall be given by taking that the far UE uses quadrature phase shift keying (QPSK) and the near UE uses QPSK Gray mapping as an example, in which it is assumed that the near UE uses a maximum likelihood receiver to demodulate data.

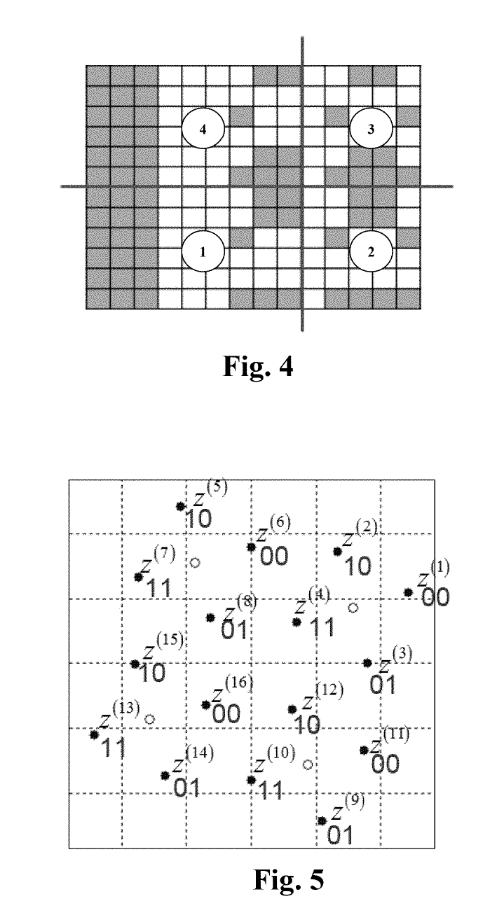

FIG. 5 is a schematic diagram of a constellation of the superimposed symbols after the constellation transform of the embodiment of this disclosure, in which a case of a rotated complex constellation obtained under a condition of power allocation of the far UE:the near UE=4:1 is shown. As shown in FIG. 5, z(ⁱ), i=1, K, 16 in the figure denotes 16 constellation points of a complex constellation formed by superimposition. FIG. 5 shows a complex constellation formed by superimposition at non-Gray mapping.

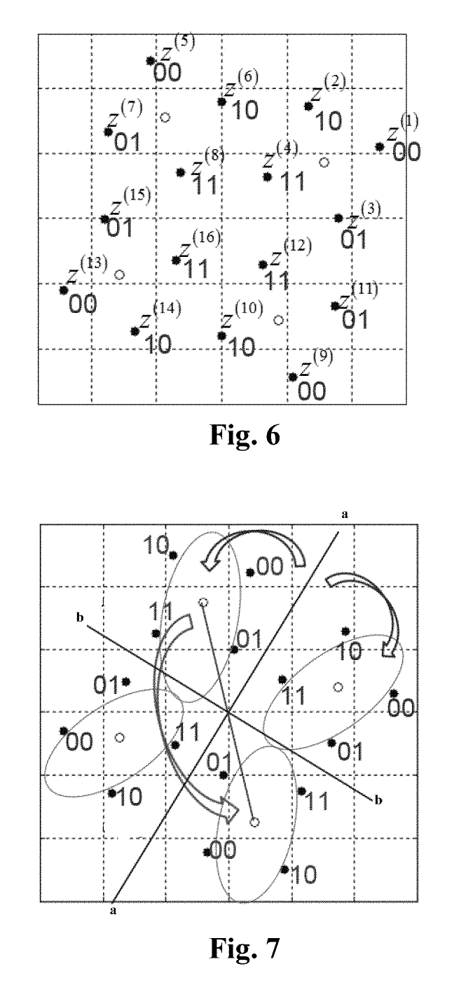

FIG. 6 is another schematic diagram of the constellation of the superimposed symbols after the constellation transform of the embodiment of this disclosure, in which the constellation of the superimposed symbols at the Gray mapping is shown. It should be noted that FIG. 6 only shows a case of two bits transmitted to the near UE, and does not show a case of four bits contained for the far UE, although the fact that two bits are transformed into four bits and the Gray mapping is satisfied is clear to those skilled in the art.

In block 101 of this embodiment, phase rotation by a rotational angle of θ₁ may further be performed on the first symbols transmitted to the first receiving device, and phase rotation may be performed on the second symbols transmitted to the second receiving device based respectively on θ₁ and θ₂ according to constellation points to which the first symbols correspond, so that the constellation points in the complex constellation formed by the superimposed symbols are symmetrically distributed. In particular, the phase rotation based on θ₁ and θ₂ may include following rotational angles: θ₁+θ₂, θ₁−θ₂, θ₁+π−θ₂ and θ₁+π+θ₂.

For example, for the constellation transform of the near UE, a manner of symmetrical rotation may also be used. Taking superimposition of two QPSK constellations as an example,

constellation rotation of the far UE may be expressed as follows (with subscripts being omitted):

a=q_{f}·e^{-j}^{^{θ}}¹;

and constellation rotation of the near UE may be expressed as follows:

$$b = \{ \begin{matrix}{q}_{n} \cdot {e}^{- j ( {θ}_{2} + {θ}_{1} )} , & {q}_{f} = \frac{1}{\sqrt{2}} + j \frac{1}{\sqrt{2}} \\ {q}_{n} \cdot {e}^{- j ( {θ}_{1} - {θ}_{2} )} , & {q}_{f} = - \frac{1}{\sqrt{2}} + j \frac{1}{\sqrt{2}} \\ {q}_{n} \cdot {e}^{- j ( {θ}_{1} + π - {θ}_{2} )} , & {q}_{f} = \frac{1}{\sqrt{2}} - j \frac{1}{\sqrt{2}} \\ {q}_{n} \cdot {e}^{- j ( {θ}_{1} + π + {θ}_{2} )} , & {q}_{f} = - \frac{1}{\sqrt{2}} - j \frac{1}{\sqrt{2}}\end{matrix} ; \\ where , {q}_{n} , {q}_{f} ∈ \{ \frac{1}{\sqrt{2}} + j \frac{1}{\sqrt{2}} , - \frac{1}{\sqrt{2}} + j \frac{1}{\sqrt{2}} , \frac{1}{\sqrt{2}} - j \frac{1}{\sqrt{2}} , - \frac{1}{\sqrt{2}} - j \frac{1}{\sqrt{2}} \} ,$$

are QPSK constellation points.

That is, the rotation angle of the near UE differs dependent on different symbols of the far UE superimposed by the near UE, and the constellation points of the near UE are symmetrically rotated relative to the rotated constellation points of the far UE.

FIG. 7 is a further schematic diagram of the constellation of the superimposed symbols after the constellation transform of the embodiment of this disclosure, in which a complex constellation formed by the superimposed symbols not satisfying the Gray mapping but satisfying symmetrical rotation is shown. As shown in FIG. 7, the complex constellation is symmetrical about the line aa, and at the same time, it is symmetrical about the line bb.

It should be noted that the complex constellations formed by the superimposed symbols satisfying the Gray mapping and/or satisfying symmetrical rotation are illustrated above; for example, appropriate transform may be performed on the second symbols according to the constellations of the first symbols, so that complex constellations satisfy the Gray mapping and/or satisfy symmetrical rotation.

Furthermore, the above description is given by taking the QPSK as an example. However, this disclosure is not limited thereto, other modulation schemes, such as 16 QAM and 64 QAM, are also applicable, and a particular implementation may be determined according to an actual situation.

In this embodiment, after the first receiving device and the second receiving device receive the signals transmitted by the transmitting device, de-interleaving may be performed on the real parts and the imaginary parts.

For the first receiving device, when a modulation scheme of the second receiving device is unknown, the first symbols may be demodulated and decoded by taking the second symbols as interference based on the constellations used by the first symbols; and when the modulation scheme of the second receiving device is known, the first symbols may be demodulated and decoded based on the complex constellation formed by superimposition of the first symbols and the second symbols. And for the second receiving device, the second symbols may be demodulated and decoded based on the complex constellation formed by superimposition of the first symbols and the second symbols.

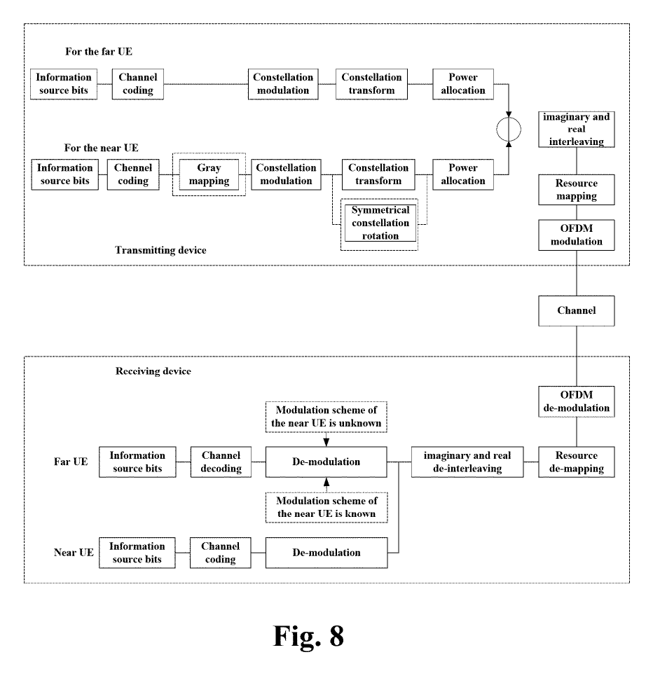

FIG. 8 is an overall schematic diagram of performing information transmission of the embodiment of this disclosure, in which processing the information transmitted to the first receiving device and the second receiving device at the transmitting device and respectively processing the received signals at the receiving device are shown.

As shown in FIG. 8, the transmitting device may perform constellation transform respectively on the first symbols and the second symbols, and perform real parts and imaginary parts interleaving on the superimposed symbols. And furthermore, it may perform Gray mapping and/or symmetrical constellation rotation on the second symbols, so that the complex constellations formed by the superimposed symbols satisfy the Gray mapping and/or satisfy symmetrical distribution.

In this embodiment, the rotational angles θ₁ and θ₂ for performing the constellation transform may be determined based on a symbol error rate.

A method for optimizing a value of a selected angle shall be given below by taking that a ratio of the power allocated for the first receiving device to the power allocated for the second receiving device is 4:1 as an example.

In one implementation, in a case where the complex constellation formed by the superimposed symbols satisfies the Gray mapping but does not satisfy symmetrical distribution, θ₁=16°, θ₂=30°, or θ₁=15°, θ₂=0°, or θ₁=45°, θ₂=0°.

In this implementation, an optimized rotational angle may be obtained by using an expression of an upper limit of the symbol error rate based on an equivalent receiving and transmitting model y_{R}=h_{R}\sqrt{Eₛ}z_{R}+n_{R}, y₁=h_{I}\sqrt{Eₛ}z_{R}+n_{I}.

Performance of the near UE shall be optimized by selecting a suitable rotational angle as below. And for the symbol error rate of the near UE, there exists an upper limit:

$${P}_{e} \leq \frac{1}{16} {\sum }_{i = 1}^{16} {\sum }_{k = 1 , k ∉ {Γ}^{( i )}}^{16} P ( {z}^{( i )} \to {z}^{( k )} ) ;$$

where,

Γ⁽¹⁾=Γ⁽⁵⁾=Γ⁽⁹⁾=Γ⁽¹³⁾={1, 5, 9, 13}

Γ⁽²⁾=Γ⁽⁶⁾=Γ⁽¹⁰⁾=Γ⁽¹⁴⁾={2, 6, 10, 14}

Γ⁽³⁾=Γ⁽⁷⁾=Γ⁽¹¹⁾=Γ⁽¹⁵⁾={3, 7, 11, 15}

Γ⁽⁴⁾=Γ⁽⁸⁾=Γ⁽¹²⁾=Γ⁽¹⁶⁾={4, 8, 12, 16},

and P(z⁽ⁱ⁾→z^{(k)}) denotes a pair-wise error probability, that is, a probability wrongly judged as z^{(k)} under a condition of transmitting z⁽ⁱ⁾, which may be further written as:

P(z⁽ⁱ⁾→z^{(k)})=∫₀²⁸ ∫₀^{∞}P(z⁽ⁱ⁾→z^{(k)}|h_{R}, h_{I})p(h_{R})p(h_{I})dh_{R}dh_{I};

where, h_{R} and h_{I} respectively denote channels experienced by the real parts and the imaginary parts, and P(z⁽ⁱ⁾→z^{(k)}|h_{R}, h_{I}) denotes a condition error probability when the channels are known, which may be written as follows after calculation:

$$\begin{matrix}P ( {z}^{( i )} \to {z}^{( k )} \vert {h}_{R} , {h}_{I} ) = P ( {( {y}_{R} - \sqrt{{E}_{s}} {h}_{R} {z}_{R}^{( k )} )}^{2} + {( {y}_{I} - \sqrt{{E}_{s}} {h}_{I} {z}_{I}^{( k )} )}^{2} \leq \\ {( {y}_{R} - \sqrt{{E}_{s}} {h}_{R} {z}_{R}^{( i )} )}^{2} + {( {y}_{I} - \sqrt{{E}_{s}} {h}_{I} {z}_{I}^{( i )} )}^{2} \vert \\ {z}^{( i )} sent ) ; \\ = \frac{1}{2} erfc ( \frac{1}{2} \sqrt{\frac{{E}_{s}}{{σ}^{2}}} \\ \sqrt{{{h}_{R}^{2} ( {z}_{R}^{( i )} - {z}_{R}^{( k )} )}^{2} + {{h}_{I}^{2} ( {z}_{R}^{( i )} - {z}_{R}^{( k )} )}^{2}} )\end{matrix}$$

where, z_{R}⁽ⁱ⁾ and z_{I}⁽ⁱ⁾ respectively the real part and the imaginary part of z⁽ⁱ⁾. Under a Rayleigh channel condition, P(z⁽ⁱ⁾→z^{(k)}) may be scaled as follows by using an inequality erfc(x)≤exp(−x²):

$$\begin{matrix}P ( {z}^{( i )} \to {z}^{( k )} ) \leq \frac{1}{2} {\int }_{0}^{∞} {\int }_{0}^{∞} {e}^{- \frac{{E}_{s}}{4 {σ}^{2}} ( {{h}_{R}^{2} ( {z}_{R}^{( i )} - {z}_{R}^{( k )} )}^{2} + {{h}_{I}^{2} ( {z}_{I}^{( i )} - {z}_{I}^{( k )} )}^{2} )} \\ {e}^{- {h}_{R}} {e}^{- {h}_{I}} {dh}_{R} {dh}_{I} , \\ = \frac{1}{2 ( 1 + \frac{{E}_{s}}{4 {σ}^{2}} {( {z}_{R}^{( i )} - {z}_{R}^{( k )} )}^{2} ) ( 1 + \frac{{E}_{s}}{4 {σ}^{2}} {( {z}_{I}^{( i )} - {z}_{I}^{( k )} )}^{2} )}\end{matrix}$$

thereby finally obtaining:

$${P}_{e} \leq \frac{1}{32} {\sum }_{i = 1}^{16} {\sum }_{k = 1 , k ∉ {Γ}^{( i )}}^{16} \frac{1}{( 1 + \frac{{E}_{s}}{4 {σ}^{2}} {( {z}_{R}^{( i )} - {z}_{R}^{( k )} )}^{2} ) ( 1 + \frac{{E}_{s}}{4 {σ}^{2}} {( {z}_{I}^{( i )} - {z}_{I}^{( k )} )}^{2} )} .$$

As both z_{R}⁽ⁱ⁾ and z_{I}⁽ⁱ⁾ are functions of rotational angles θ₁, θ₂, θ₁, θ₂ of minimal upper limits of Pₑ as the rotational angles. And the rotational angles are calculated as θ₁=16°, θ₂=30° by taking 1° as a minimal resolution granularity by using a numerical method.

Likewise, the method may also be used to perform performance optimization on the far UE.

In this implementation, under a condition that the modulation scheme of the near UE is known to the far UE, the rotational angles may be calculated as θ₁=15°, θ₂=0°. And at this moment, an expression of the upper limit of the symbol error rate is:

$${P}_{e} \leq \frac{1}{16} {\sum }_{i = 1}^{16} {\sum }_{k = 1 , k ∉ {Γ}^{( i )}}^{16} P ( {z}^{( i )} \to {z}^{( k )} ) ;$$

where,

Γ⁽¹⁾=Γ⁽²⁾=Γ⁽³⁾=Γ⁽⁴⁾={1, 2, 3, 4}

Γ⁽⁵⁾=Γ⁽⁶⁾=Γ⁽⁷⁾=Γ⁽⁸⁾={5, 6, 7, 8}

Γ⁽⁹⁾=Γ⁽¹⁰⁾=Γ⁽¹¹⁾=Γ⁽¹²⁾={9, 10, 11, 12}

Γ⁽¹³⁾=Γ⁽¹⁴⁾=Γ⁽¹⁵⁾=Γ⁽¹⁶⁾={13, 14, 15, 16}

and definitions of other symbols are as those described above.

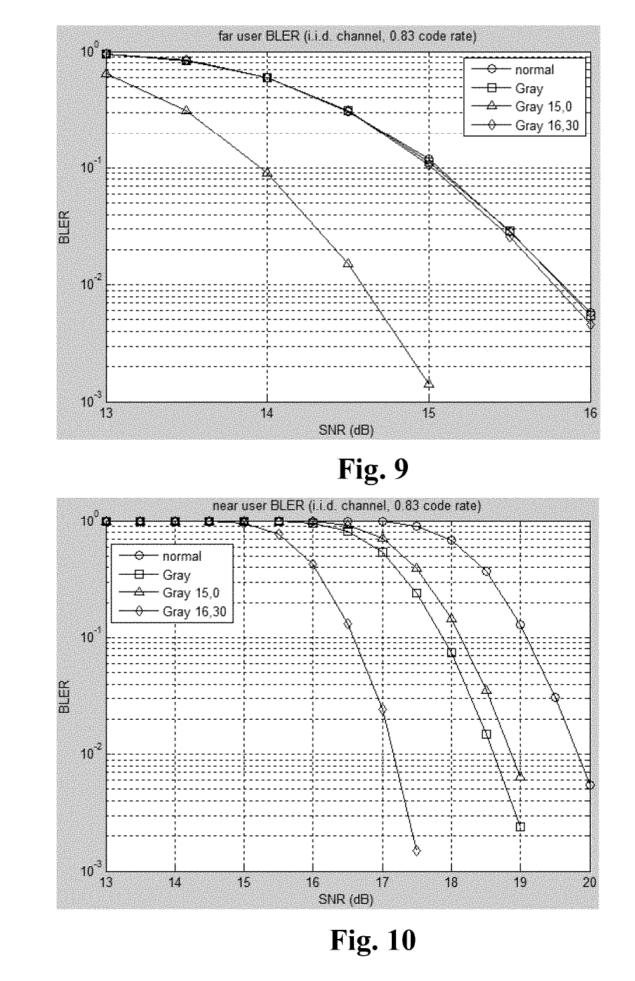

FIG. 9 is a schematic diagram of performance comparison of the embodiment of this disclosure, in which comparison of performance of the method of this disclosure under the Rayleigh channel condition and performance of the conventional NOMA is given. In the figure, normal denotes NOMA not using the Gray mapping, referred to as conventional NOMA; Gray denotes NOMA using the Gray mapping, referred to as Gray mapping NOMA; Gray 16, 30 denotes the method for optimizing performance of the near UE in this disclosure; and Gray 15, 0 denotes the method for optimizing performance of the far UE in this disclosure.

As shown in FIG. 9, in comparison with the Gray mapping NOMA, if it is selected that the performance of the near UE is optimized, that is, the Gray 16, 30 method is used, for a block error rate of 0.1, the near UE may obtain a performance gain of 1.2 dB, while performance loss is not posed by the method to the far UE.

FIG. 10 is another schematic diagram of performance comparison of the embodiment of this disclosure. As shown in FIG. 10, if it is selected that the performance of the far UE is optimized, that is, the Gray 15, 0 method is used, for a block error rate of 0.1, the far UE may obtain a performance gain of 1 dB, while few performance loss is posed to the near UE, which is about 0.2 dB.

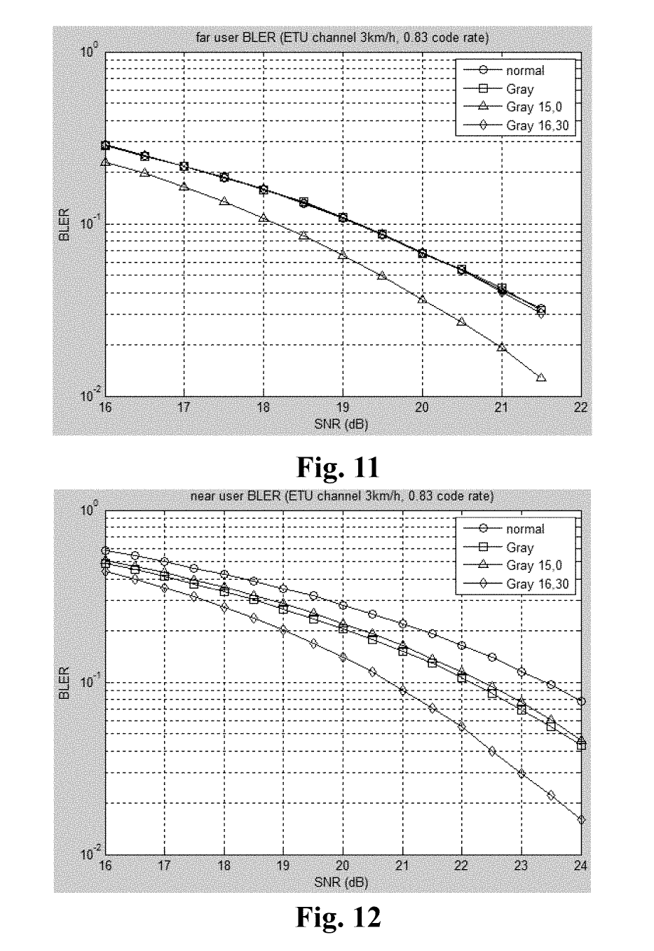

FIG. 11 is a further schematic diagram of performance comparison of the embodiment of this disclosure, and FIG. 12 is still another schematic diagram of performance comparison of the embodiment of this disclosure, in which simulation results under an ETU 3 km/h channel condition are shown, with performance gains being similar to those as described above.

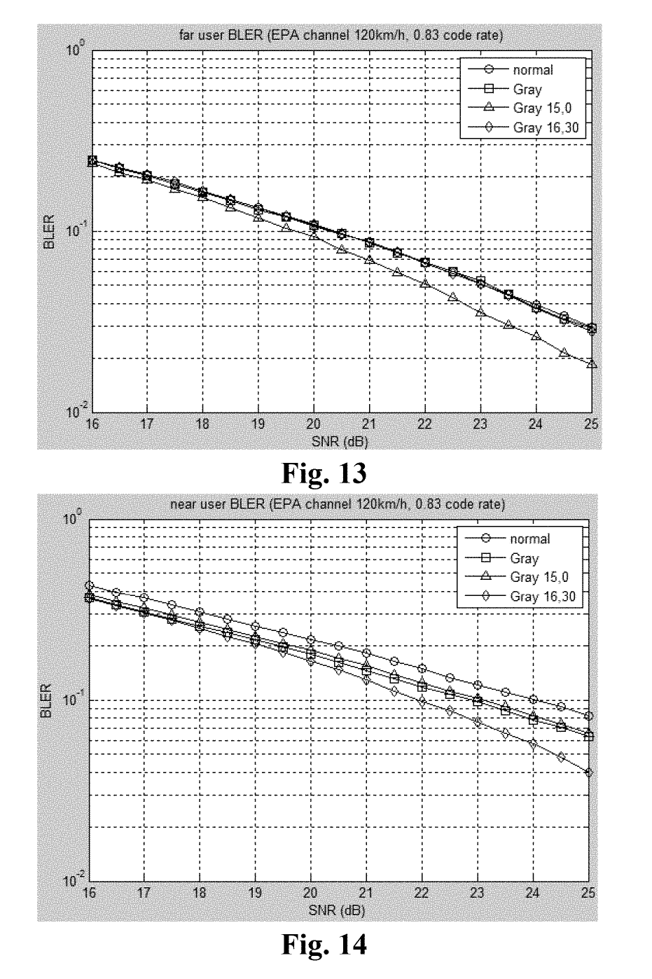

FIG. 13 is yet another schematic diagram of performance comparison of the embodiment of this disclosure, and FIG. 14 is yet still another schematic diagram of performance comparison of the embodiment of this disclosure, in which simulation results under an EPA 120 km/h channel condition are shown.

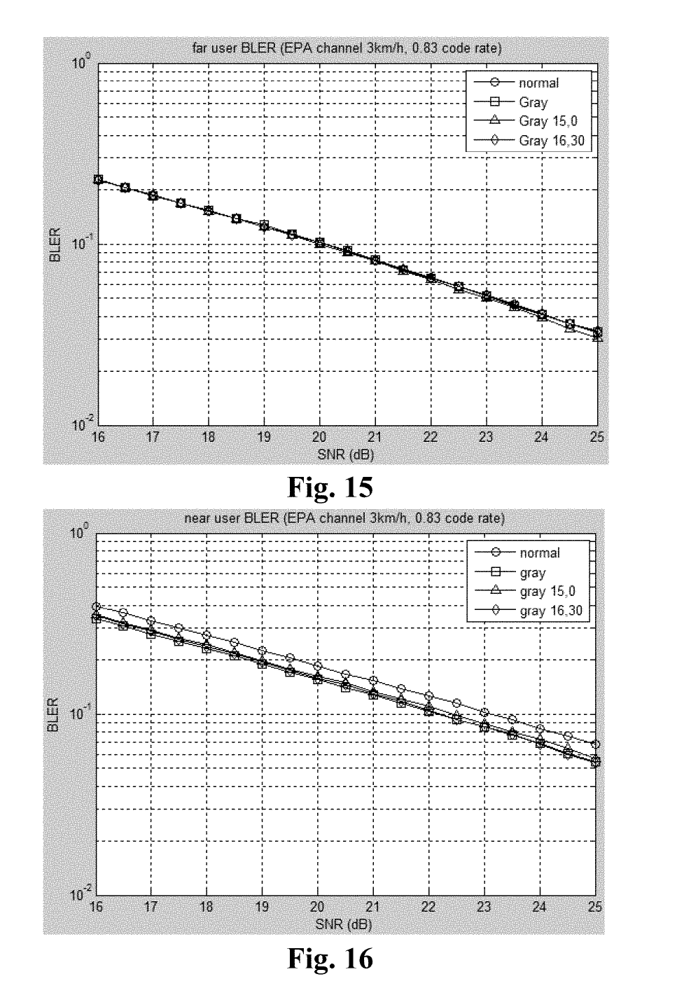

FIG. 15 is a still further schematic diagram of performance comparison of the embodiment of this disclosure, and FIG. 16 is a yet further schematic diagram of performance comparison of the embodiment of this disclosure, in which simulation results under an EPA 3 km/h channel condition are shown.

It may be found through wide simulations and tests of different channels that when a channel condition tends to be an independent, identically distributed Rayleigh channel, such as an ETU 3 km/h frequency selective channel or an EPA 120 km/h fast fading channel, the method of this disclosure is able to provide relatively outstanding performance gains (a magnitude of about 1 dB). And when a channel condition tends to be an additive white Gaussian noise channel, such as an EPA 3 km/h flat slow fading channel, gains tend to be reduced or lost, and the method of this disclosure has a performance approximately identical to that of the Gray mapping NOMA.

In this implementation, under the condition that the modulation scheme of the near UE is unknown to the far UE, the equivalent receiving and transmitting model may be written as follows (with subscripts being omitted for the sake of not inducing confusion):

y_{R}=h_{R}\sqrt{Eₛ}(\sqrt{P₁}w_{R}+\sqrt{P₂}s_{R})+n_{R}

y_{I}=h_{I}\sqrt{Eₛ}(\sqrt{P₁}w_{I}+\sqrt{P₂}s_{I})+n_{I};

where,

wᵣ=real(a·e^{-j}^{^{θ}}¹), w_{I}=imag(a·e^{-j}^{^{θ}}¹)

s_{R}=real(b·e^{-j}^{^{θ}}²), s_{I}=imag(b·e^{-j}^{^{θ}}²).

For such a model, under the condition that the modulation scheme of the near UE is unknown to the far UE, the upper limit of the symbol error rate of the Rayleigh channel may be obtained through calculation, which is as shown below:

$${P}_{e} \leq \frac{1}{32} {\sum }_{i = 1}^{4} {\sum }_{k = 1 , k \neq i}^{4} {\sum }_{l = 1}^{4} {\int }_{0}^{∞} {\int }_{0}^{∞} erfc ( \frac{1}{2} \sqrt{\frac{{E}_{s}}{{σ}^{2}}} ( \sqrt{{P}_{1}} \sqrt{{uR}_{i , k}^{2} + {vI}_{i , k}^{2}} + 2 \sqrt{{P}_{2}} \frac{{us}_{R}^{( l )} {R}_{i , k} + {vs}_{I}^{( l )} {I}_{i , k}}{\sqrt{{uR}_{i , k}^{2} + {vI}_{i , k}^{2}}} ) ) {e}^{- u} {e}^{- v} dudv ;$$

where,

R_{i,k}=w_{R}⁽ⁱ⁾−w_{R}^{(k)}, I_{i,k}=w_{I}⁽ⁱ⁾−w_{I}^{(k)}, u=h_{R}², v=h_{I}².

For this upper limit of the symbol error rate, under the condition that the modulation scheme of the near UE is unknown to the far UE, optimal (referring to optimality at a least meaning of the upper limit of the symbol error rate, and 1° is taken as a minimal resolution granularity) rotational angles are calculated as θ₁=45°, θ₂=0°.

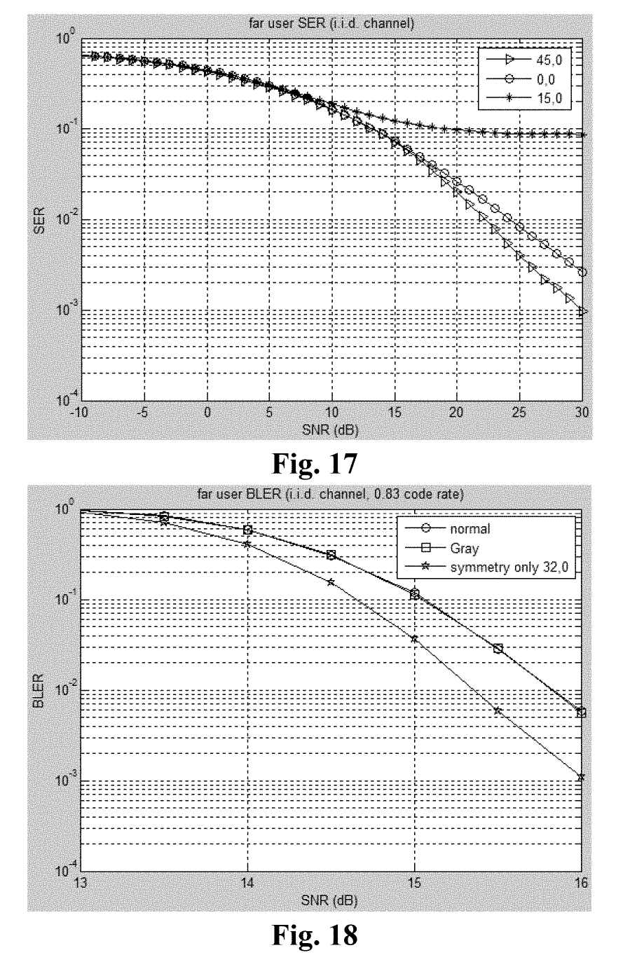

FIG. 17 is a yet still further schematic diagram of performance comparison of the embodiment of this disclosure, in which a curve of the symbol error rate using θ₁=45°, θ₂=0° is shown. In the figure, in the two curves in comparison with the curve, (0, 0) denotes the conventional NOMA method, and (15, 0) denotes a selected group of rotational angles. It can be seen from FIG. 17 that the optimized angles (45, 0) may be able to obtain performances better than the conventional NOMA and other cases of arbitrary rotation.

In another implementation, in a case where the complex constellation formed by the superimposed symbols satisfies the Gray mapping and satisfies the symmetrical distribution, θ₁=0°, θ₂=29°, or θ₁=32°, θ₂=0°, or θ₁=45°, θ₂=45°.

In this implementation, it is assumed that the near UE uses the Gray mapping and uses the symmetrical rotation.

For the performance optimization of the near UE, optimal rotation angles may be calculated as θ₁=0°, θ₂=29°.

For the performance optimization of the far UE, optimal rotation angles may be calculated as θ₁=32°, θ₂=0° under the condition that the modulation scheme of the near UE is known to the far UE, and optimal rotation angles may be calculated as θ₁=45°, θ₂=45° under the condition that the modulation scheme of the near UE is unknown to the far UE.

In this implementation, the previous implementation may be referred to for how to obtain the above angles and the performance comparison.

In another implementation, in a case where the complex constellation formed by the superimposed symbols does not satisfy the Gray mapping and does not satisfy the symmetrical distribution, θ₁=1°, θ₂=27°, or θ₁=15°, θ₂=0°, or θ₁=45°, θ₂=0°.

In this implementation, it is assumed that the near UE does not use the Gray mapping and does not use the symmetrical rotation.

For the performance optimization of the near UE, optimal rotation angles may be calculated as θ₁=1°, θ₂=27°.

For the performance optimization of the far UE, optimal rotation angles may be calculated as θ₁=15°, θ₂=0° under the condition that the modulation scheme of the near UE is known to the far UE, and optimal rotation angles may be calculated as θ₁=45°, θ₂=0° under the condition that the modulation scheme of the near UE is unknown to the far UE.

In this implementation, the previous implementation may be referred to for how to obtain the above angles and the performance comparison.

In another implementation, and in a case where the complex constellation formed by the superimposed symbols does not satisfy the Gray mapping but satisfies the symmetrical distribution, θ₁=32°, θ₂=0°, or θ₁=45°, θ₂=45°.

In this implementation, it is assumed that the near UE does not use the Gray mapping but uses the symmetrical rotation.

For the performance optimization of the near UE, optimal rotation angles may be calculated as θ₁=32°, θ₂=0°.

For the performance optimization of the far UE, optimal rotation angles may be calculated as θ₁=32°, θ₂=0° under the condition that the modulation scheme of the near UE is known to the far UE; and it can be seen that optimization of the near UE and the far UE in this method is consistent, that is, θ₁=32°, θ₂=0° can optimize the performance of the far UE and the near UE at the same time.

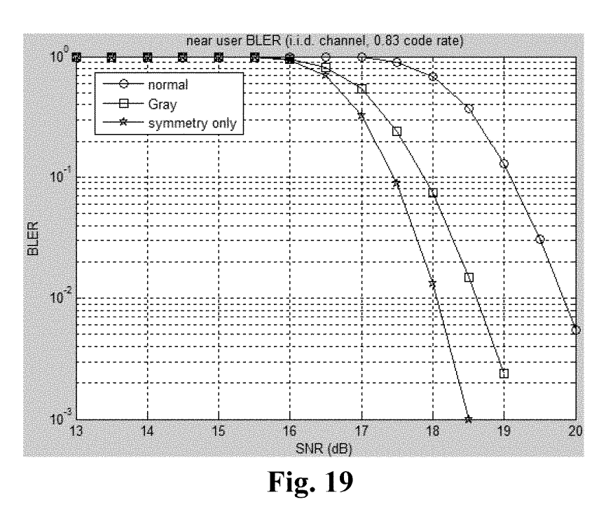

FIG. 18 is even another schematic diagram of performance comparison of the embodiment of this disclosure, and FIG. 19 is an even further schematic diagram of performance comparison of the embodiment of this disclosure, in which simulation results under the Rayleigh channel condition are given. As shown in FIGS. 18 and 19, it can be seen when the group of rotational angles are used, both the far UE and the near UE have a gain of about 0.5 dB relative to the Gray mapping NOMA.

In this implementation, optimal rotation angles may be calculated as θ₁=45°, θ₂=45° under the condition that the modulation scheme of the near UE is unknown to the far UE.

In this implementation, the previous implementation may be referred to for how to obtain the above angles and the performance comparison.

How to perform performance optimization by the rotational angles is illustrated above. And in order to obtain the above performance gains, some important parameters correspondingly need to be configured and notified by using signaling.

In this embodiment, the information transmission method may further include: the transmitting device transmits first configuration information to the first receiving device, the first configuration information including rotational angles θ₁ and θ₂ for performing the constellation transform, a modulation scheme of the second receiving device and information on whether the complex constellation formed by the superimposed symbols is symmetrically distributed, or the first configuration information including the rotational angle θ₁ for performing the constellation transform; and

the transmitting device transmits second configuration information to the second receiving device, the second configuration information including the rotational angles θ₁ and θ₂ for performing the constellation transform, information on whether the complex constellation formed by the superimposed symbols satisfies the Gray mapping and information on whether the complex constellation formed by the superimposed symbols is symmetrically distributed.

For example, first, a base station may configure whether the UE uses constellation transform by using signaling according to an actual situation; the base station may configure and notify whether the near UE uses the Gray mapping by using the signaling; and the base station may configure and notify whether the near UE uses the symmetrical rotation by using the signaling; for example, the signaling may include dynamic signaling (such as a PDCCH), or semi-static signaling (such as radio resource control (RRC)).

In this embodiment, a particular example of a format of PDCCH signaling supporting NOMA constellation rotation is given below for a case where dynamic signaling (such as a PDCCH) is used for configuration.

For example, a new downlink control information (DCI) format x is defined for the NOMA downlink transmission, and the following information is transmitted via the DCI format x:
***constellation transform indication, such as one bit; such a field is used to indicate whether constellation transform is used. For example, “1” indicates the constellation transform is used, particular values of rotational angles at this moment being designated by a field of a subsequent rotational angle; and “0” indicates the constellation transform is not used, a field of a subsequent rotational angle at this moment being reserved and not functioning;
*** rotational angles, such as n bits;

such a field is used to indicate a used rotational angle pair, i.e., (θ₁, θ₂); where, θ₁, θ₂ respectively denote rotational angles of the far UE and the near UE, and n bits may indicate 2ⁿ rotational angle combinations, that is,

(θ₁⁽¹⁾, θ₂⁽¹⁾), (θ₁⁽²⁾, θ₂⁽²⁾), . . . , (θ₁²^{ⁿ}⁾), θ₂⁽²^{ⁿ}⁾);

the 2ⁿ rotational angle combinations may be defined in a standard in advance, which exist in a form of, for example, a lookup table; hence, they be commonly known by both a reception side and a transmission side; or the 2ⁿ rotational angle combinations may be semi-statically configured for the UE via RRC signaling, and then one of the combinations is dynamically selected via the field of the rotational angles of the DCI format x;
*** far and near UE type indication, such as one bit;

such a field is used to indicate whether current UE is far UE or near UE; based on this field, the UE may learn a type to which itself belongs in NOMA scheduling pairing, so as to be able to select correct rotational angles and power coefficients;
*** power coefficients, such as m bits;

such a field is used to indicate power allocation coefficients, i.e., (ρ₁, ρ₂); where, ρ₁, ρ₂ respectively denote power coefficients of the far UE and the near UE; and the coefficients may also be defined as a power ratio of data symbols to reference signals; for example, the reference signal may be common reference signal (CRS) or demodulation reference signal (DMRS); and the m bits may indicate 2^{m} power allocation combinations, that is,

(ρ₁⁽¹⁾, ρ₂⁽¹⁾), (ρ₁⁽²⁾, ρ₂⁽²⁾), . . . , (ρ₁⁽²^{^{m}}⁾, ρ₂⁽²^{^{m}}⁾);

the 2^{m} power allocation combinations may be defined in a standard in advance, which exist in a form of, for example, a lookup table; hence, they be commonly known by both the reception side and the transmission side; or the 2^{m} power allocation combinations may be semi-statically configured for the UE via RRC signaling, and then one of the combinations is dynamically selected via the field of the power coefficients of the DCI format x signaling;
*** far UE modulation coding scheme (MCS), such as 5 bits; and
*** near UE MCS, such as 5 bits;

the above two fields are used to indicate modulation coding schemes of the far UE and the near UE, each piece of UE having two transport blocks (TBs), each TB corresponding to an MCS field; and the UE may select an MCS to which itself corresponds according to the far and near UE type indication.

It should be noted that key fields in the DCI format x used for supporting NOMA functions are only described above. Other function fields (such as carrier indication, and resource block allocation, etc.) may reuse formats in other DCI in the standards, which shall not be described herein any further. And furthermore, the above fields are not necessary, and the DCI format x may only include some field therein.

In this embodiment, another PDCCH signaling format (DCI format y) is given below, which may reuse the power allocation field to indicate the rotational angles, hence, its signaling overhead is lower.

For example, following information is transmitted via the DCI format y:
*** constellation transform indication, such as one bit;
*** far and near UE type indication, such as one bit;
*** power coefficients/rotational angles, such as m bits;
*** far UE MCS, such as 5 bits; and
*** near UE MCS, such as 5 bits.

Functions of the above fields except the power coefficients/rotational angles field are identical to those as described in the DCI format x. And it should be noted that n bits of rotational angles field is reduced here in comparison with the DCI format x, that is, the rotational angles are not indicated by using an individual field, but m bits of the power coefficients are reused to indicate the rotational angles.

In the DCI format y, for the 2^{m} power allocation combinations, there exist 2^{m} rotational angle combinations corresponding them one by one. Hence, the m bits field uniquely determines used rotational angles while indicating determination of the power coefficients, thereby achieving not only indication of results of power allocation, but also indication of the rotational angles.

For the power coefficients/rotational angles field, it is simultaneously used to indicate the power allocation coefficients (ρ₁, ρ₂) and the rotational angles (θ₁, θ₂). And the m bits may indicate the 2^{m} power allocation combinations, that is,

(ρ₁⁽¹⁾, ρ₂⁽¹⁾), (ρ₁⁽²⁾, ρ₂⁽²⁾), . . . , (ρ₁⁽²^{^{m}}⁾, ρ₂⁽²^{^{m}}⁾);

and may indicate the 2^{m} rotational angle combinations at the same time, that is,

(θ₁⁽¹⁾, θ₂⁽¹⁾), (θ₁⁽²⁾, θ₂⁽²⁾), . . . , (θ₁⁽²^{^{m}}⁾, θ₂⁽²^{^{m}}⁾).

The 2^{m} power allocation combinations and 2^{m} rotational angle combinations may be defined in a standard in advance, which exist in a form of, for example, a lookup table; hence, they be commonly known by both the reception side and the transmission side; or the 2^{m} power allocation combinations and 2^{m} rotational angle combinations may be semi-statically configured for the UE via RRC signaling, and then one of the power allocation combinations and one of the power allocation combinations are dynamically selected via the power coefficients/rotational angle field of the DCI format y signaling.

The dynamical signaling configuration is illustrated above by taking the DCI format x and the DCI format y as examples. However, this disclosure is not limited thereto, and a particular implementation may be determined according to a particular scenario.

For another example, for the rotational angles of the far UE and the near UE, the group of parameters may be fixed as particular numerical values, hence, they are commonly known by the base station and the UE, and at this moment, they are not needed to be configured by using signaling.

Furthermore, for the rotational angles of the far UE and the near UE, the group of parameters may be configured for the far UE and the near UE by the base station by using signaling. For the near UE, a maximum likelihood method is used for demodulation, signaling is needed to notify information on the two rotational angles (the rotational angle of the near UE and the rotational angle of the far UE) to the near UE, and at the same time, signaling may be used to indicate whether the near UE uses the Gray mapping, and whether the near UE uses the symmetrical rotation.

For the demodulation when the modulation scheme of the near UE is known to the far UE, signaling is needed to notify information on the two rotational angles (the rotational angle of the near UE and the rotational angle of the far UE) to the far UE, the modulation scheme of the near UE is needed to be notified to the far UE, and at the same time, whether the near UE uses the symmetrical rotation may be notified to the far UE in a signaling manner.

For the demodulation when the modulation scheme of the near UE is unknown to the far UE, signaling is needed to notify information on a rotational angle (the rotational angle of the far UE) to the far UE, and the modulation scheme of the near UE is not needed to be notified to the far UE.

It can be seen from the above embodiment that the transmitting device performs constellation transform respectively on the first symbols to be transmitted to the first receiving device and the second symbols to be transmitted to the second receiving device, performs power allocation and superimposition, to form superimposed symbols, and then interleaves the imaginary parts and real parts of the superimposed symbols. Hence, data demodulation performance of the UE may further be improved on the basis of the conventional NOMA.

### Embodiment 2

The embodiment of this disclosure provides an information transmission apparatus, configured at a transmitting device of an NOMA system. The embodiment of this disclosure corresponds to the information transmission method in Embodiment 1, with identical contents being not going to be described herein any further.

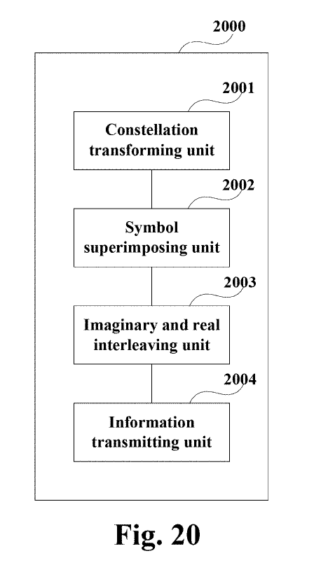

FIG. 20 is a schematic diagram of the information transmission apparatus of the embodiment of this disclosure. As shown in FIG. 20, the information transmission apparatus 2000 includes:

a constellation transforming unit 2001 configured to perform constellation transform respectively on first symbols to be transmitted to a first receiving device and second symbols to be transmitted to a second receiving device;

a symbol superimposing unit 2002 configured to perform power allocation respectively and superimposition on the constellation transformed first symbols and the constellation transformed second symbols to form superimposed symbols;

an imaginary and real interleaving unit 2003 configured to interleave imaginary parts and real parts of the superimposed symbols; and

an information transmitting unit 2004 configured to transmit the superimposed symbols with the imaginary parts and real parts being interleaved.

It should be noted that only some units related to this disclosure are shown in FIG. 20, and techniques relevant to NOMA and OFDM may be referred to for other units for transmitting information (such as components carrying out channel coding, constellation modulation, resource mapping, and OFDM symbol modulation, etc.), which shall not be described herein any further.

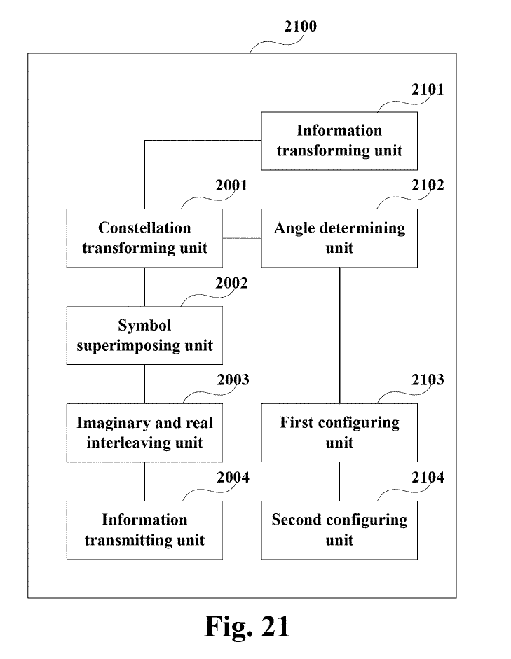

FIG. 21 is another schematic diagram of the information transmission apparatus of the embodiment of this disclosure. As shown in FIG. 21, the information transmission apparatus 2100 includes a constellation transforming unit 2001, a symbol superimposing unit 2002, an imaginary and real interleaving unit 2003 and an information transmitting unit 2004, as described above.

As shown in FIG. 21, the information transmission apparatus 2100 may further include:

an information transforming unit 2101 configured to transform the second symbols to be transmitted to the second receiving device, so that bits to which constellation points in a complex constellation formed by the superimposed symbols correspond satisfy Gray mapping.

In this embodiment, the constellation transforming unit 2001 may further include: a first rotating unit configured to perform phase rotation on the first symbols to be transmitted to the first receiving device by a rotational angle of θ₁. Furthermore, the constellation transforming unit 2001 may include a second rotating unit or a third rotating unit.

For example, the second rotating unit is configured to perform phase rotation on the second symbols to be transmitted to the second receiving device by a rotational angle of θ₂, and the third rotating unit is configured to respectively perform phase rotation on the second symbols to be transmitted to the second receiving device based on θ₁ and θ₂ according to constellation points to which the first symbols correspond, so that the constellation points in the complex constellation formed by the superimposed symbols are symmetrically distributed. And the phase rotation based on θ₁ and θ₂ may include following rotational angles: θ₂+θ₂, θ₁−θ₂, θ₁+π−θ₂ and θ₁+π+θ₂; however, this disclosure is not limited thereto.

As shown in FIG. 21, the information transmission apparatus 2100 may further include: an angle determining unit 2102 configured to, based on a symbol error rate, determine the rotational angles θ₁ and θ₂ for performing the constellation transform.

Optimally selected angle values shall be given below by taking that a ratio of the power allocated for the first receiving device to the power allocated for the second receiving device is 4:1 as an example. For other cases of power allocation, the above-described method may be used to obtain optimized angle values.

For example, in a case where the complex constellation formed by the superimposed symbols satisfies the Gray mapping but does not satisfy symmetrical distribution, θ₁=16°, θ₂=30°, or θ₁=15°, θ₂=0°, or θ₁=45°, θ₂=0°; in a case where the complex constellation formed by the superimposed symbols satisfies the Gray mapping and satisfies the symmetrical distribution, θ₁=0°, θ₂=29°, or θ₁=32°, θ₂=0°, or θ₁=45°; in a case where the complex constellation formed by the superimposed symbols does not satisfy the Gray mapping and does not satisfy the symmetrical distribution, θ₁=1°, θ₂=27°, or θ₁=15°, θ₂=0°, or θ₁=45°, θ₂=0°; and in a case where the complex constellation formed by the superimposed symbols does not satisfy the Gray mapping but satisfies the symmetrical distribution, θ₁=32°, θ₂=0°, or θ₁=45°, θ₂=45°.

As shown in FIG. 21, the information transmission apparatus 2100 may further include:

a first configuring unit 2103 configured to transmit first configuration information to the first receiving device, the first configuration information including rotational angles θ₁ and θ₂ for performing the constellation transform, a modulation scheme of the second receiving device and indication on whether constellation points in a complex constellation formed by the superimposed symbols are symmetrically distributed, or the first configuration information including the rotational angle θ₁ for performing the constellation transform; and

a second configuring unit 2104 configured to transmit second configuration information to the second receiving device, the second configuration information including the rotational angles θ₁ and θ₂ for performing the constellation transform, indication on whether the complex constellation formed by the superimposed symbols satisfies the Gray mapping and indication on whether the complex constellation formed by the superimposed symbols is symmetrically distributed.

In this embodiment, the first configuration information and/or the second configuration information may be configured via dynamic signaling. For example, the dynamic signaling may include the following information: constellation transform indication, rotational angle information, UE type indication, power coefficient information, and a UE modulation coding scheme; or may include the following information: constellation transform indication, UE type indication, rotational angle/power coefficient information, and a UE modulation coding scheme.

This embodiment further provides a transmitting device, configured with the above-described information transmission apparatus 2000 or 2100.

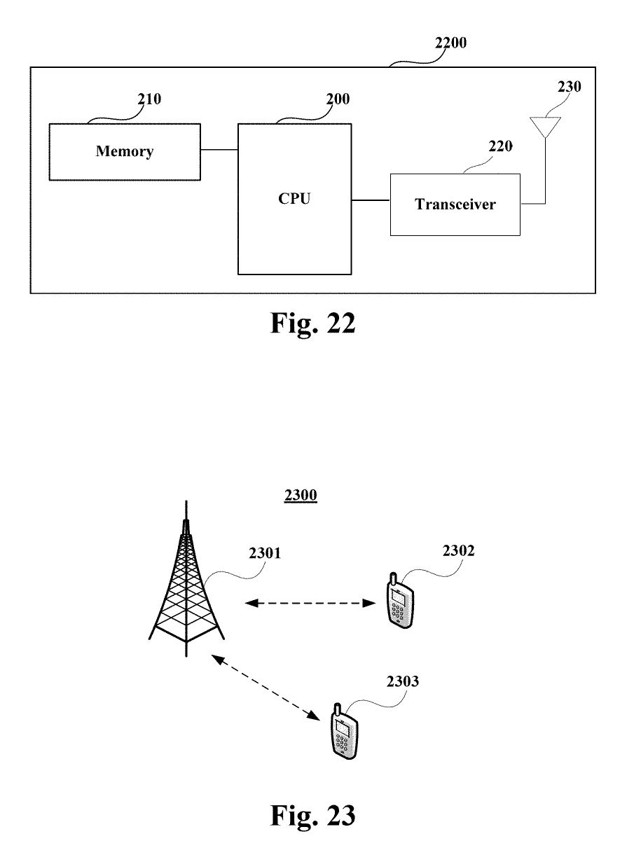

FIG. 22 is a schematic diagram of a structure of the transmitting device of the embodiment of this disclosure. As shown in FIG. 22, the transmitting device 2200 may include a central processing unit (CPU) 200 and a memory 210, the memory 210 being coupled to the central processing unit 200. The memory 210 may store various data, and furthermore, it may store a program for information processing, and execute the program under control of the central processing unit 200.

For example, the transmitting device 2200 may carry out the information transmission method described in Embodiment 1. And the central processing unit 200 may be configured to execute functions of the information transmission apparatus 2000 or 2100.

Furthermore, as shown in FIG. 22, the transmitting device 2200 may include a transceiver 220, and an antenna 230, etc. Functions of the above components are similar to those in the relevant art, and shall not be described herein any further. It should be noted that the transmitting device 2200 does not necessarily include all the parts shown in FIG. 22, and furthermore, the transmitting device 2200 may include parts not shown in FIG. 22, and the relevant art may be referred to.

It can be seen from the above embodiment that the transmitting device performs constellation transform respectively on the first symbols to be transmitted to the first receiving device and the second symbols to be transmitted to the second receiving device, performs power allocation and superimposition to form superimposed symbols, and then interleaves the imaginary parts and real parts of the superimposed symbols. Hence, data demodulation performance of the UE may further be improved on the basis of the conventional NOMA.

### Embodiment 3

The embodiment of this disclosure provides a communications system, configured to perform NOMA transmission, with contents identical to those in embodiments 1 and 2 being not going to be described herein any further.

FIG. 23 is a schematic diagram of the communications system of the embodiment of this disclosure. As show in FIG. 23, the communications system 2300 includes:

a transmitting device 2301 configured to perform constellation transform respectively on first symbols to be transmitted to a first receiving device and second symbols to be transmitted to a second receiving device, perform power allocation respectively on the constellation transformed first symbols and the constellation transformed second symbols and superimposition to form superimposed symbols, and interleave imaginary parts and real parts of the superimposed symbols and then transmit the superimposed symbols;

the first receiving device 2302 configured to receive signals transmitted by the transmitting device and de-interleave imaginary parts and real parts of the signals, in a case where a modulation scheme of the second receiving device is unknown, take the second symbols as interference, and demodulate and decode the first symbols based on a constellation used by the first symbols, and in a case where the modulation scheme of the second receiving device is known, demodulate and decode the first symbols based on a complex constellation formed by superimposing the first symbols and the second symbols; and

the second receiving device 2303 configured to receive signals transmitted by the transmitting device and de-interleave imaginary parts and real parts of the signals, and demodulate and decode the second symbols based on the complex constellation formed by superimposing the first symbols and the second symbols.

An embodiment of the present disclosure further provides a computer readable program code, which, when executed in a transmitting device, will cause a computer unit to carry out the information transmission method described in Embodiment 1 in the transmitting device.

An embodiment of the present disclosure further provides a computer storage medium, including a computer readable program code, which will cause a computer unit to carry out the information transmission method described in Embodiment 1 in a transmitting device.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An information transmission apparatus, configured in a nonorthogonal multiple access (NOMA) system, the information transmission apparatus comprising:
a constellation transforming unit configured to perform constellation transform respectively on first symbols to be transmitted to a first receiving device and second symbols to be transmitted to a second receiving device;
a symbol superimposing unit configured to perform power allocation respectively and superimposition on the constellation transformed first symbols and the constellation transformed second symbols, to form superimposed symbols;
an imaginary and real interleaving unit configured to interleave imaginary parts and real parts of the superimposed symbols; and
an information transmitting unit configured to transmit the superimposed symbols with the imaginary parts and real parts being interleaved.

2. The information transmission apparatus according to claim 1, wherein the information transmission apparatus further comprises:
an information transforming unit configured to transform the second symbols to be transmitted to the second receiving device, so that bits to which constellation points in a complex constellation formed by the superimposed symbols correspond satisfy Gray mapping.

3. The information transmission apparatus according to claim 1, wherein the constellation transforming unit comprises:
a first rotating unit configured to perform phase rotation on the first symbols by a rotational angle of θ₁; and
a second rotating unit configured to perform phase rotation on the second symbols by a rotational angle of θ₂.

4. The information transmission apparatus according to claim 1, wherein the constellation transforming unit comprises:
a first rotating unit configured to perform phase rotation on the first symbols by a rotational angle of θ₁; and
a third rotating unit configured to perform phase rotation on the second symbols based on θ₁ and θ₂ according to constellation points to which the first symbols correspond, so that the constellation points in a complex constellation formed by the superimposed symbols are symmetrically distributed.

5. The information transmission apparatus according to claim 4, wherein the phase rotation based on θ₁ and θ₂ comprises following rotational angles: θ₁+θ₂, θ₁−θ₂, θ₁+π−θ₂ and θ₁+π+θ₂.

6. The information transmission apparatus according to claim 1, wherein the information transmission apparatus further comprises:
an angle determining unit configured to, based on a symbol error rate, determine the rotational angles θ₁ and θ₂ for performing the constellation transform.

7. The information transmission apparatus according to claim 6, wherein when a ratio of the power allocated for the first receiving device to the power allocated for the second receiving device is 4:1,
in a case where the constellation points in a complex constellation formed by the superimposed symbols satisfy the Gray mapping but not satisfy symmetrical distribution, θ=16°, θ₂=30°, or θ₁=15°, θ₂=0°, or θ₁=45°, θ₂=0°;
in a case where the constellation points in the complex constellation formed by the superimposed symbols satisfy the Gray mapping and satisfy the symmetrical distribution, θ₁=0°, θ₂=29°, or θ₁=32°, θ₂=0°, or θ₁=45°, θ₂=45°;
in a case where the constellation points in the complex constellation formed by the superimposed symbols do not satisfy the Gray mapping and do not satisfy the symmetrical distribution, θ₁=1°, θ₂=27°, or θ₁=15°, θ₂=0°, or θ₁=45°, θ₂=0°;
and in a case where the constellation points in the complex constellation formed by the superimposed symbols do not satisfy the Gray mapping but satisfy the symmetrical distribution, θ₁=32°, θ₂=0°, or θ₁=45°, θ₂=45°.

8. The information transmission apparatus according to claim 1, wherein the information transmission apparatus further comprises:
a first configuring unit configured to transmit first configuration information to the first receiving device; the first configuration information comprising rotational angles θ₁ and θ₂ for performing the constellation transform, a modulation scheme of the second receiving device and indication on whether constellation points in a complex constellation formed by the superimposed symbols are symmetrically distributed, or the first configuration information comprising the rotational angle t9 for performing the constellation transform; and
a second configuring unit configured to transmit second configuration information to the second receiving device; the second configuration information comprising the rotational angles θ₁ and θ₂ for performing the constellation transform, indication on whether the constellation points in the complex constellation formed by the superimposed symbols satisfy the Gray mapping and indication on whether the constellation points in the complex constellation formed by the superimposed symbols are symmetrically distributed.

9. The information transmission apparatus according to claim 8, wherein the first configuration information and/or the second configuration information is/are configured via dynamic signaling;
the dynamic signaling comprising the following information: constellation transform indication, rotational angle information, user equipment type indication, power coefficient information, and a user equipment modulation coding scheme; or comprising the following information: constellation transform indication, user equipment type indication, rotational angle/power coefficient information, and a user equipment modulation coding scheme.

10. An information transmission method, applicable to a nonorthogonal multiple access (NOMA) system, the information transmission method comprising:
performing, by a transmitting device, constellation transform respectively on first symbols to be transmitted to a first receiving device and second symbols to be transmitted to a second receiving device;
performing power allocation respectively on the constellation transformed first symbols and the constellation transformed second symbols and superimposition, to form superimposed symbols;
interleaving imaginary parts and real parts of the superimposed symbols; and
transmitting the superimposed symbols with the imaginary parts and real parts being interleaved.

11. The information transmission method according to claim 10, wherein before the transmitting device performs constellation transform on the second symbols to be transmitted to the second receiving device, the information transmission method further comprises:
transforming the second symbols to be transmitted to the second receiving device, so that bits to which constellation points in a complex constellation formed by the superimposed symbols correspond satisfy Gray mapping.

12. The information transmission method according to claim 10, wherein the performing constellation transform respectively by a transmitting device on first symbols to be transmitted to a first receiving device and second symbols to be transmitted to a second receiving device comprises:
performing phase rotation on the first symbols by a rotational angle of θ₁; and
performing phase rotation on the second symbols by a rotational angle of θ₂.

13. The information transmission method according to claim 10, wherein the performing constellation transform respectively by a transmitting device on first symbols to be transmitted to a first receiving device and second symbol to be transmitted to a second receiving device comprises:
performing phase rotation on the first symbols by a rotational angle of θ₁; and
performing phase rotation on the second symbols based on θ₁ and θ₂ according to constellation points to which the first symbols corresponds, so that the constellation points in a complex constellation formed by the superimposed symbols are symmetrically distributed.

14. The information transmission method according to claim 13, wherein the phase rotation based on θ₁ and θ₂ comprises following rotational angles: θ₁+θ₂, θ₁−θ₂, θ₁+π−θ₂, θ₁+π+θ₂.

15. The information transmission method according to claim 10, wherein the information transmission method further comprises:
determining rotational angles θ₁ and θ₂ for performing the constellation transform based on a symbol error rate.

16. The information transmission method according to claim 15, wherein when a ratio of power allocated for the first receiving device to power allocated for the second receiving device is 4:1,
in a case where the constellation points in a complex constellation formed by the superimposed symbols satisfy the Gray mapping but not satisfy symmetrical distribution, θ₁=16°, θ₂=30°, or θ₁=15°, θ₂=0°, or θ₁=45°, θ₂=0°;
in a case where the constellation points in the complex constellation formed by the superimposed symbols satisfy the Gray mapping and satisfy the symmetrical distribution, θ₁=0°, θ₂=29°, or θ₁=32°, θ₂=0°, or θ₁=45°, θ₂=45°;
in a case where the constellation points in the complex constellation formed by the superimposed symbols do not satisfy the Gray mapping and do not satisfy the symmetrical distribution, θ₁=1°, θ₂=27°, or θ₁=15°, θ₂=0°, or θ₁=45°, θ₂=0°;
and in a case where the constellation points in the complex constellation formed by the superimposed symbols do not satisfy the Gray mapping but satisfy the symmetrical distribution, θ₁=32°, θ₂=0°, or θ₁=45°, θ₂=45°.

17. The information transmission method according to claim 10, wherein the information transmission method further comprises:
transmitting first configuration information to the first receiving device; the first configuration information comprising rotational angles θ₁ and θ₂ for performing the constellation transform, a modulation scheme of the second receiving device and indication on whether constellation points in a complex constellation formed by the superimposed symbols are symmetrically distributed, or the first configuration information comprising the rotational angle θ₁ for performing the constellation transform; and
transmitting second configuration information to the second receiving device; the second configuration information comprising the rotational angles θ₁ and θ₂ for performing the constellation transform, indication on whether the constellation points in the complex constellation formed by the superimposed symbols satisfy the Gray mapping and indication on whether the constellation points in the complex constellation formed by the superimposed symbols are symmetrically distributed.

18. The information transmission method according to claim 17, wherein the first configuration information and/or the second configuration information is/are configured via dynamic signaling;
the dynamic signaling comprising the following information: constellation transform indication, rotational angle information, user equipment type indication, power coefficient information, and a user equipment modulation coding scheme; or comprising the following information: constellation transform indication, user equipment type indication, rotational angle/power coefficient information, and a user equipment modulation coding scheme.

19. A communications system, configured to perform nonorthogonal multiple access (NOMA), the communications system comprising:
a transmitting device configured to perform constellation transform respectively on first symbols to be transmitted to a first receiving device and second symbols to be transmitted to a second receiving device, perform power allocation respectively on the constellation transformed first symbols and the constellation transformed second symbols and superimposition to form superimposed symbols, and interleave imaginary parts and real parts of the superimposed symbols and then transmit the superimposed symbols;
the first receiving device configured to receive signals transmitted by the transmitting device and de-interleave imaginary parts and real parts of the signals, in a case where a modulation scheme of the second receiving device is unknown, take the second symbols as interference, and demodulate and decode the first symbols based on a constellation used by the first symbols, and in a case where the modulation scheme of the second receiving device is known, demodulate and decode the first symbols based on a complex constellation formed by superimposing the first symbols and the second symbols; and
the second receiving device configured to receive signals transmitted by the transmitting device and de-interleave imaginary parts and real parts of the signals, and demodulate and decode the second symbols based on the complex constellation formed by superimposing the first symbols and the second symbols.
